(19) United States
(12) Patent Application Publication
(10) Pub. No.: US 2026/0011992 A1
(43) Pub. Date: Jan. 8, 2026

(54) WIRING MODULE

(71) Applicants: Sumitomo Wiring Systems, Ltd., Mie (JP); TOYOTA JIDOSHA KABUSHIKI KAISHA, Aichi (JP)

(72) Inventors: Kengo OKADA, Mie (JP); Atsushi KURODA, Mie (JP); Junya YONEKAWA, Mie (JP); Koichi YAMAGA, Mie (JP); Masataka YAMAUCHI, Mie (JP); Akinori ISHIKAWA, Aichi (JP); Mitsuhiro KATO, Aichi (JP)

(73) Assignees: Sumitomo Wiring Systems, Ltd., Mie (JP); TOYOTA JIDOSHA KABUSHIKI KAISHA, Aichi (JP)

(21) Appl. No.: 19/245,767

(22) Filed: Jun. 23, 2025

(30) Foreign Application Priority Data
Jun. 28, 2024 (JP) 2024-105026

(51) Int. Cl. H02G 3/00; B60R 16/02

(52) U.S. Cl. CPC H02G 3/263; B60R 16/0215

(57) ABSTRACT

A wiring module is attached to a fixation target elongated on one side. The wiring module includes a flat wiring member extending along an elongated direction of the fixation target and a protector attaching the flat wiring member to the fixation target. The protector includes a support part supporting the flat wiring member and a fixing part and an insertion part each protruding from the support part to a side opposite to a side on which the flat wiring member is supported A protrusion dimension of the insertion part is larger than a protrusion dimension of the fixing part.

### BACKGROUND

### Technical Field

The present disclosure relates to a wiring module.

### Description of the Background Art

Patent Document 1 discloses a technique of making a rod-like member such as a reinforcement support a flat wire harness. A support member described in Japanese Patent Application Laid-Open No. 2019-4679 includes a positioning protrusion part fitted to a concave part of the rod-like member.

### SUMMARY

Since a flat wire harness extends in a width direction, a positioning protrusion part is easily hidden in attaching the wire harness. Desired is improvement of attachment operability of the wire harness.

Accordingly, an object is to provide a technique capable of improving attachment operability of a wiring module.

A wiring module according to the present disclosure is a wire module attached to a fixation target elongated on one side, including: a flat wiring member extending along an elongated direction of the fixation target; and a protector attaching the flat wiring member to the fixation target, wherein the protector includes a support part supporting the flat wiring member and a fixing part and an insertion part each protruding from the support part to a side opposite to a side on which the flat wiring member is supported, and a protrusion dimension of the insertion part is larger than a protrusion dimension of the fixing part.

According to the present disclosure, attachment operability of the wiring module can be improved.

These and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view illustrating the wiring module according to an embodiment 1.

FIG. 2 is a plan view illustrating the wiring module in FIG. 1.

FIG. 3 is a front view illustrating the wiring module in FIG. 1.

FIG. 4 is a side view illustrating the wiring module in FIG. 1.

FIG. 5 is a perspective view illustrating a state where a fixation target and a wire-like member are detached from a state in FIG. 1.

FIG. 6 is a perspective view illustrating a state where a cover is detached from a state in FIG. 5.

FIG. 7 is a perspective view illustrating a state where a flat wiring member is detached from a state in FIG. 6.

FIG. 8 is a cross-sectional view along a VIII-VIII line in FIG. 7.

FIG. 9 is a front view illustrating a protector body and a cover.

FIG. 10 is a back view illustrating the protector body and the cover.

FIG. 11 is a plan view illustrating the protector body.

FIG. 12 is a side view illustrating the protector body.

FIG. 13 is a cross-sectional view of a protector along a XIII-XIII line in FIG. 11.

### DESCRIPTION OF THE PREFERRED EMBODIMENTS

### Description of Embodiments of Present Disclosure

Embodiments of the present disclosure are listed and described firstly.

A wiring module according to the present disclosure is as follows.

(1) A wiring module attached to a fixation target elongated on one side includes: a flat wiring member extending along an elongated direction of the fixation target; and a protector attaching the flat wiring member to the fixation target, wherein the protector includes a support part supporting the flat wiring member and a fixing part and an insertion part each protruding from the support part to a side opposite to a side on which the flat wiring member is supported, and a protrusion dimension of the insertion part is larger than a protrusion dimension of the fixing part.

According to the wiring module in (1), the insertion part can be elongated. Thus, the insertion part can be visually recognized easily, or a distal end of the insertion part can be easily positioned to a hole in the fixation target. Accordingly, attachment operability of the wiring module can be improved.

(2) In the wiring module according to (1), it is applicable that the support part includes a first inward surface extending to one lateral side of the fixation target from a connection part continuously formed with a base end of the insertion part to face the fixation target and a second inward surface extending to another lateral side of the fixation target from the connection part to face the fixation target, and when a virtual surface made by continuous occurrence of a line connecting a distal end of the first inward surface and a distal end of the second inward surface in a longitudinal direction of the fixation target is a reference surface, a distal end of the insertion part goes over the reference surface. Accordingly, the insertion part can be longer than the line connecting the distal end of the first inward surface and the distal end of the second inward surface when seen from a direction along the longitudinal direction of the fixation target.

(3) In the wiring module according to (1), it is applicable that the support part includes a first inward surface extending to one lateral side of the fixation target from a connection part continuously formed with a base end of the insertion part to face the fixation target and a second inward surface extending to another lateral side of the fixation target from the connection part to face the fixation target, a dimension from the insertion part to a distal end of the first inward surface is equal to or smaller than a dimension from the insertion part to a distal end of the second inward direction, and when a virtual surface passing through the distal end of the first inward surface to be perpendicular to a protrusion direction of the insertion part is a reference surface, a distal end of the insertion part goes over the reference surface. Accordingly, the insertion part can be longer than the first inward surface.

(4) In the wiring module according to (1), when a virtual surface passing through a center axis of the fixation target to be perpendicular to a protrusion direction of the insertion part is a reference surface, a distal end of the insertion part may go over the reference surface. Accordingly, the insertion part can be longer than the center axis of the fixation target.

(5) In the wiring module according to any one of (1) to (4), the fixing part may include a first fixing part provided to a base end of the insertion part to be fixed to a first fixing hole into which the insertion hole is inserted in the fixation target. Accordingly, the protector can be fixed to the fixation target at a position of the insertion part.

(6) In the wiring module according to (5), it is applicable that the fixing part includes a second fixing part fixed to a second fixing hole formed in the fixation target, and the second fixing part is shorter than the insertion part. Since the fixing part includes the first fixing part and the second fixing part, the protector can be fixed to the fixation target at a plurality of positions. At this time, since the insertion part is inserted into the first fixing hole in advance of the first fixing part and the second fixing part, the first fixing part and the second fixing part before fixation can be positioned with respect to the fixation target.

(7) In the wiring module according to (6), it is applicable that the protector includes a plate spring pressed against the fixation target, and the first fixing part, the second fixing part, and the plate spring are provided away from each other along a longitudinal direction of the fixation target. A slip of the protector with respect to the fixation target can be easily suppressed by fixation at the plurality of positions using the first fixing part and the second fixing part and the plate spring.

(8) In the wiring module according to any one of (1) to (7), it is applicable that the flat wiring member includes a base member and a plurality of wire-like transmission members fixed to the base member, a section in which the plurality of wire-like transmission members in the flat wiring member are overlapped with the base member is a first section, a section in which the plurality of wire-like transmission members extend outside the base member is a second section, the plurality of wire-like transmission members extend to be divided into a plurality of groups for each connection destination different from each other in the second section, the protector includes a partition convex part provided to the support part to partition the plurality of groups, and the partition convex part and the insertion part protrude to sides opposite to each other from a same position in the support part. Accordingly, when the protector is seen from a surface to which the partition convex part is provided, a position of the insertion part can be easily grasped based on a position of the partition convex part.

(9) In the wiring module according to (8), it is applicable that the fixing part is provided to the base end of the insertion part, and a release hole for releasing a fixing state of the fixing part fixed to the hole is formed in the partition convex part. Since the fixing part is provided to the base end of the insertion part, the protector can be fixed to the fixation target at the position of the insertion part. Since the insertion part is inserted into the hole in advance of the fixing part, the fixing part before fixation can be easily positioned to the fixation target. Since the release hole is formed in the partition convex part, a position of the release hole is easily grasped based on a position of the partition convex part. Since the plurality of groups are partitioned by the partition convex part, suppressed is the groups covering the release hole.

### Detailed Description of Embodiment of Present Disclosure

Specific examples of a wiring module of the present disclosure are described hereinafter with reference to the drawings. The present disclosure is not limited to these exemplifications, but is indicated by claims, and it is intended that meanings equivalent to claims and all modifications within a scope of claims are included.

### Embodiment 1

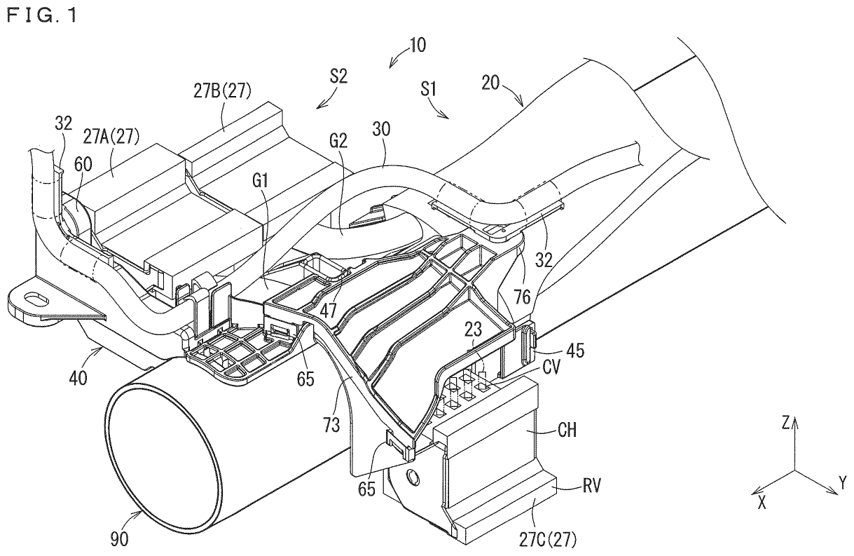

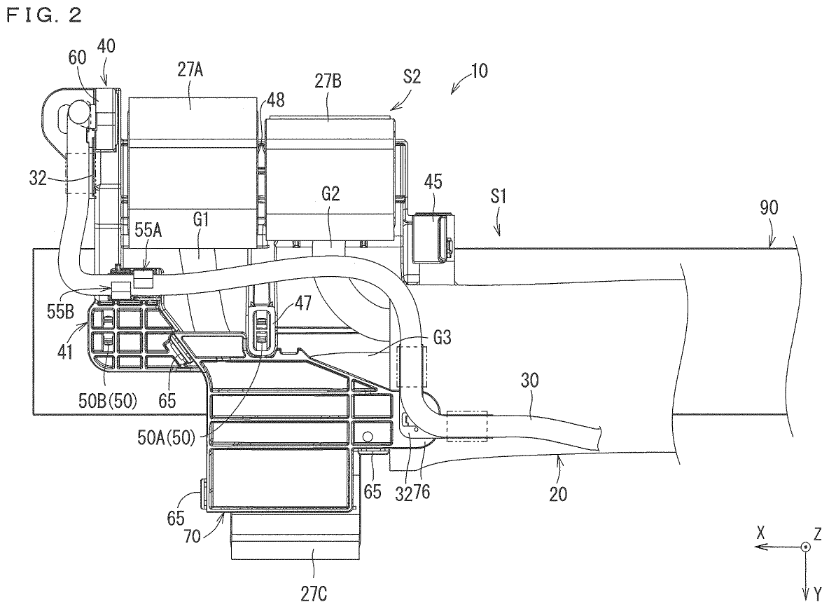

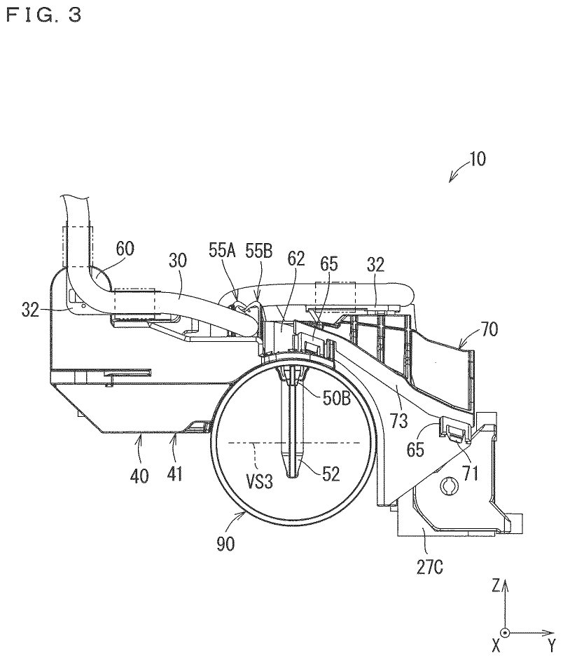

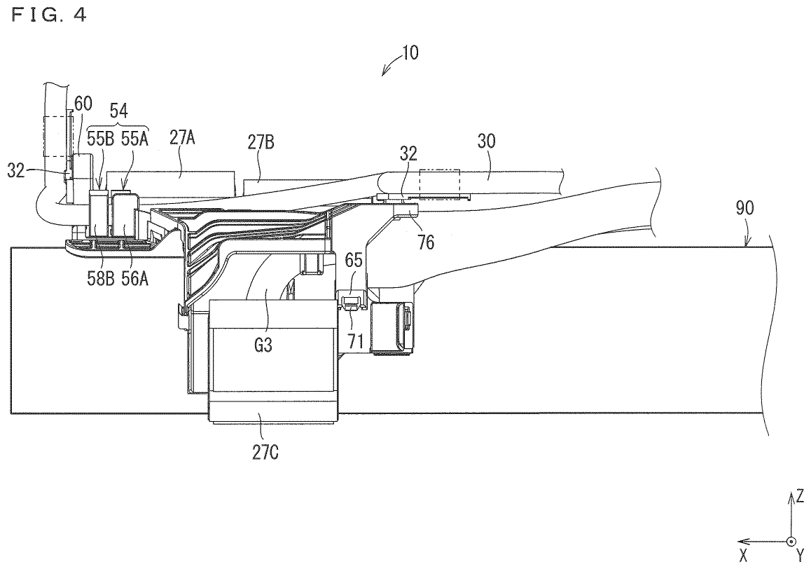

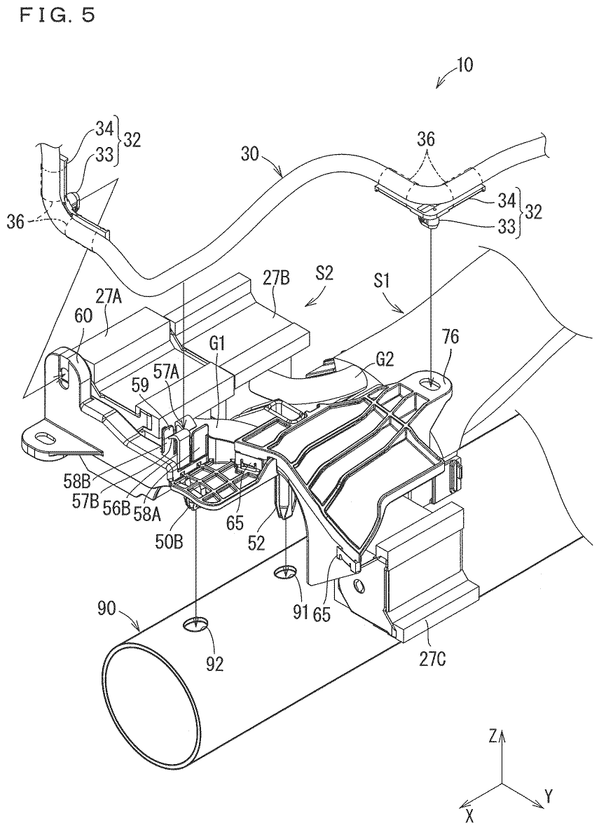

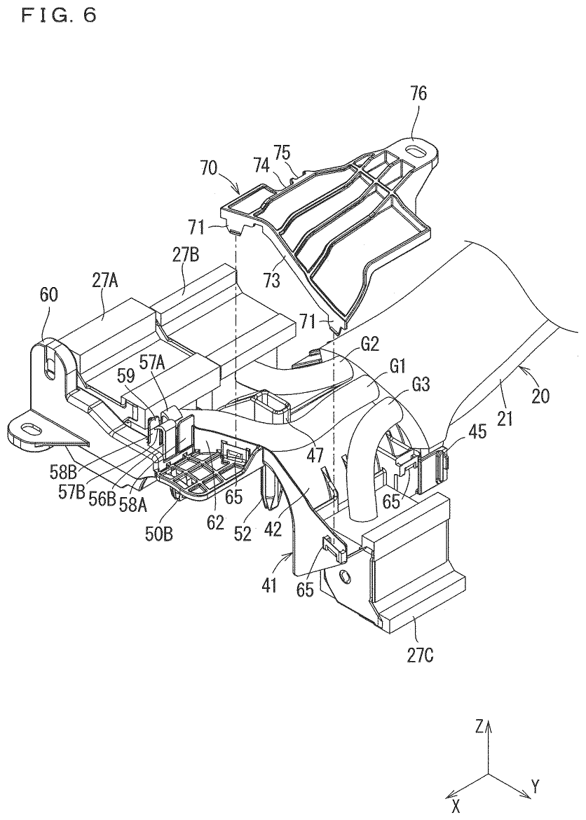

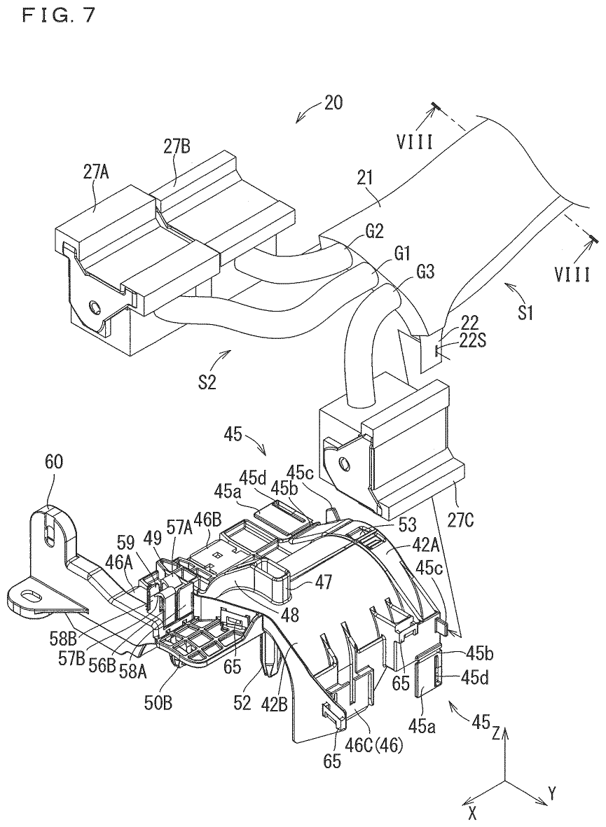

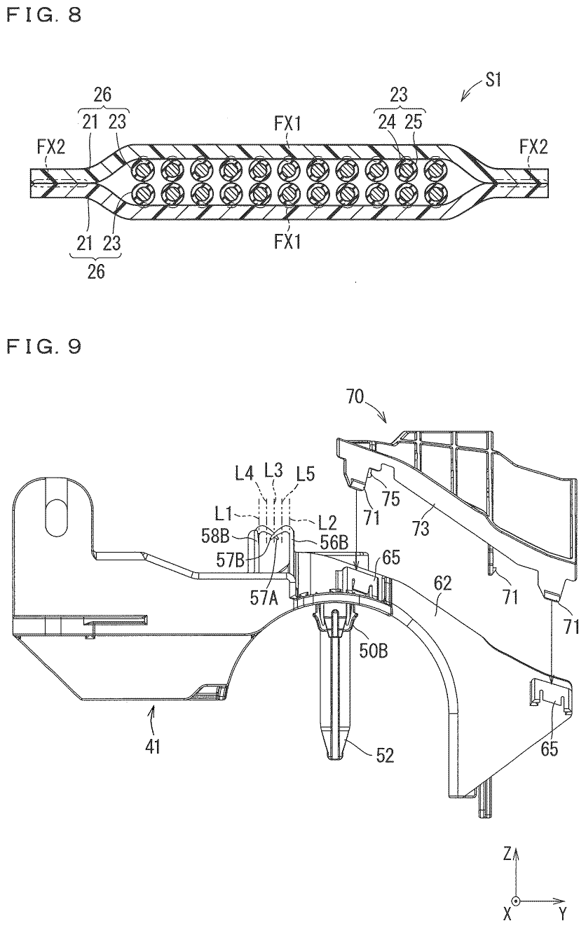

A wiring module according to an embodiment 1 is described hereinafter. FIG. 1 is a perspective view illustrating a wiring module 10 according to the embodiment 1. FIG. 2 is a plan view illustrating the wiring module 10 in FIG. 1. FIG. 3 is a front view illustrating the wiring module 10 in FIG. 1. FIG. 4 is a side view illustrating the wiring module 10 in FIG. 1. FIG. 5 is a perspective view illustrating a state where a fixation target 90 and a wire-like member 30 are detached from a state in FIG. 1. FIG. 6 is a perspective view illustrating a state where a cover 70 is detached from a state in FIG. 5. FIG. 7 is a perspective view illustrating a state where a flat wiring member 20 is detached from a state in FIG. 6. FIG. 8 is a cross-sectional view along a VIII-VIII line in FIG. 7. FIG. 8 is a horizontal cross-sectional view illustrating a first section S1 in the flat wiring member 20. Each diagram illustrates an X direction, a Y direction, and a Z direction perpendicular to each other.

The wiring module 10 includes the flat wiring member 20, wire-like member 30, and a protector 40. The wiring module 10 is fixed to the fixation target 90. The flat wiring member 20 and wire-like member 30 are fixed to the protector 40. The protector 40 is fixed to the fixation target 90. The flat wiring member 20 and wire-like member 30 are fixed to the fixation target 90 via the protector 40.

### <Fixation Target>

The fixation target 90 is a rod-like member elongated on one side, for example. The fixation target 90 may also be a reinforcement constituting a part of a vehicle body. The reinforcement may also be an instrument panel reinforcement disposed in an inner part of an instrument panel of a vehicle, for example. The instrument panel reinforcement extends along a width direction of the vehicle to connect a wall on a left side of the vehicle body and a wall on a right side of the vehicle. In the example illustrated in FIG. 1, a longitudinal direction of the fixation target 90 is the X direction. In the vehicle, the X direction is a direction along a vehicle width direction (right-left direction), the Y direction is a direction along a front-back direction, and the Z direction is a direction along an up-down direction (vertical direction).

Herein, an outer shape of a horizontal section of the fixation target 90 is a circular shape. Herein, an inner part of the fixation target 90 is hollow. Accordingly, the fixation target 90 is a cylindrical member. An outer shape of the horizontal section of the fixation target 90 may be a shape such as a rectangular shape other than a circular shape. The fixation target 90 may have a configuration without the hollow in the inner part.

As illustrated in FIG. 5, fixing holes 91 and 92 for fixing the protector 40 are formed in the fixation target 90. The fixing holes 91 and 92 are formed in an outer surface of an upper part of the fixation target 90, for example. The fixing holes 91 and 92 pass through the outer surface and an inner surface of the fixation target 90. Herein, a first fixing hole 91 and a second fixing hole 92 are formed as the fixing holes 91 and 92. The first fixing hole 91 and the second fixing hole 92 are located away from each other along the longitudinal direction of the fixation target 90.

### <Flat Wiring Member>

The flat wiring member 20 includes a base member 21, a plurality of wire-like transmission members 23, and a plurality of connectors 27. The plurality of wire-like transmission members 23 are fixed to the base member 21. The plurality of connectors 27 are provided to end portions of the plurality of wire-like transmission members 23.

It is sufficient that the base member 21 can fix the wire-like transmission member 23, thus a material and a structure, for example, are not particularly limited. With regard to a material constituting the base member 21, the base member 21 is formed of a resin material herein. A material other than resin such as metal or an inorganic material, for example, may be used for the material constituting the base member 21.

The structure of the base member 21 may be a single layer structure, or a multilayer structure of two or more layers is also applicable. For example, the base member 21 includes a fusion layer. The wire-like transmission member 23 is fused and fixed to the fusion layer. The fusion layer includes a resin material, or preferably includes a thermoplastic resin material. The resin material of the fusion layer is softened and fused to a fusion target. A type of the resin material is not particularly limited, but polyvinyl chloride (PVC), polyethylene (PE), polypropylene (PP), or polyethylene terephthalate (PET) can be adopted, for example.

A structure of the fusion layer is not particularly limited. For example, the fusion layer may be a sheet having an evenly filled cross-sectional surface (also referred to as a non-foam sheet or a solid sheet, for example). The fusion layer is also considered a foam sheet, for example. The fusion layer is also considered a fibrous material sheet such as a braided cloth, a woven cloth, or a non-woven cloth, for example.

The base member 21 may include a fusion layer and an additional layer. The additional layer is formed of a material different from that of the fusion layer, or has a different structure. The additional layer increases a function of the fusion layer, or adds a function which the fusion layer does not have to the base member 21. A material constituting the additional layer is a material described for the fusion layer described above, metal, or an inorganic material, for example. A structure of the additional layer may be any of the structure described for the fusion layer described above.

The fusion layer and the additional layer are fixed to each other while surfaces thereof have contact with each other. A fixing state of the fusion layer and the additional layer is not particularly limited, however, fixing by fusion or adhesion is preferable. For example, when at least one of the fusion layer and the additional layer is a sheet having voids in a surface such as a fibrous material sheet or a foam sheet, a resin material or an adhesive agent enters the voids and the layers can be fixed to each other. Such a configuration causes so-called anchor effect, thus the fusion layer and the additional layer are rigidly fixed.

For example, it is applicable that the fusion layer is a solid sheet made of resin, the additional layer is a fibrous material sheet, and the fusion layer and the additional layer are fused to each other. The resin of the fusion layer enters between the fibers of the additional layer while having flowability, and is then hardened. Accordingly, a state where the resin of the fusion layer enters between the fibers of the additional layer is maintained, and the fusion layer and the additional layer are rigidly fixed.

The fusion layer and the additional layer may be formed to have the same size (the same planar shape). One of the fusion layer and the additional layer may also be formed to be larger than the other one thereof. The fusion layer and the additional layer may be wholly fixed at a region where they have contact with each other, or may also be fixed only at a part of a region where they have contact with each other.

The base member 21 may be a flexible member. For example, it is applicable that the fusion layer is a solid sheet made up of flexible resin such as flexible PVC as a material, the additional layer is a non-woven cloth made up of PET as a material, and the base member 21 is a flexible member. For example, the base member 21 may have plasticity so as to be able to follow bending of the wire-like transmission member 23. It is also applicable that the flat wiring member 20 can be bended in a thickness direction (bending so that a fold line follows the holding surface of the base member 21).

The wire-like transmission member 23 is a wire-like member transmitting electricity or light, for example. The wire-like transmission member 23 is assumed to be a member connecting components in a vehicle. As illustrated in FIG. 8, the wire-like transmission member 23 includes a transmission wire body 24 and a covering layer 25. The transmission wire body 24 is a transmission path transmitting electricity or light. For example, when the wire-like transmission member 23 is an electrical wire, the transmission wire body 24 is a conductor core wire. The conductor core wire is made up of one or a plurality of strands. The strand is formed of copper, copper alloy, aluminum, or aluminum alloy as a material, for example. When the wire-like transmission member 23 is an optical fiber, the transmission wire body 24 is a core and a clad. The covering layer 25 is a layer covering the transmission wire body 24. For example, when the wire-like transmission member 23 is an electrical wire, the covering layer 25 is an insulating covering. The covering layer 25 is formed by a resin material, for example. A resin material constituting the covering layer 25 is not particularly limited, but can be appropriately set.

For example, the wire-like transmission member 23 may be a general electrical wire having a core wire and a covering layer around the core wire, or may also be a shielded wire, a twisted wire, an enamel wire, a nichrome wire, or an optical fiber. The wire-like transmission member 23 transmitting the electricity may be various kinds of signal lines or various kinds of power lines. Some of the wire-like transmission members 23 transmitting the electricity may be used as an antenna or coil, for example, transmitting or receiving a signal or electrical power to or from a space.

The wire-like transmission member 23 may be a single core wire. The single core wire is a single wire-like object. The single core wire is the wire-like transmission member with one transmission path. The wire-like transmission member 23 may be a multicore wire. The multicore wire is a compound body of a plurality of wire-like objects. The multicore wire is the wire-like transmission member with a plurality of transmission paths. The multicore wire may be a cable made up of collected twisted wires or a plurality of wire-like objects covered by a sheath, for example.

Applicable as the fixing state of the base member 21 and the wire-like transmission member 23 are a contact area fixation and a non-contact area fixation, or both fixations may be used together. Herein, the contact area fixation indicates that a portion where the base member 21 and the wire-like transmission member 23 have contact with each other is stuck and fixed. The non-contact area fixation is a fixing state which is not the contact area fixation, and indicates that a sewing thread, a cover, or an adhesive tape presses the wire-like transmission member 23 toward the base member 21 or sandwiches the base member 21 and the wire-like transmission member 23 to keep them in a fixing state.

Applicable as the configuration of the contact area fixation are a contact area indirect fixation and a contact area direct fixation, or both fixations may also be used together in different regions. Herein, the contact area indirect fixation indicates that the base member 21 and the wire-like transmission member 23 are indirectly stuck and fixed via an adhesive agent, a gluing agent, and a double-sided adhesive tape provided therebetween. The contact area direct fixation indicates that the base member 21 and the wire-like transmission member 23 are directly stuck and fixed without an intervention of the adhesive agent, for example, which is separately provided. Considered in the contact area direct fixation is that resin included in at least one of the base member 21 and the wire-like transmission member 23 is melted, thus the base member 21 and the wire-like transmission member 23 are stuck and fixed, for example.

In forming the state of such a contact area direct fixation, the resin is considered to be melted by heat or a solvent, for example. That is to say, the state of the contact area direct fixation may be the state of the contact area direct fixation by the heat or the state of the contact area direct fixation by the solvent. The contact area direct fixation by the heat is preferable.

At this time, a means of forming the state of the contact area direct fixation is not particularly limited, but a known means such as fusion can be used. For example, when the contact area direct fixation by heat is formed by fusion, adoptable are various types of fusion means such as ultrasonic fusion, heating pressurizing fusion, hot air fusion, and high-frequency fusion. When the state of the contact area direct fixation is formed by these means, the base member 21 and the wire-like transmission member 23 are in the state of the contact area direct fixation by these means. Specifically, when the state of the contact area direct fixation is formed by the ultrasonic fusion, for example, the base member 21 and the wire-like transmission member 23 are in the state of the contact area direct fixation by the ultrasonic fusion. Accordingly, the fusion fixation described above is one aspect of the contact area direct fixation. FIG. 8 illustrates a fusion part FX1 where the base member 21 and the wire-like transmission member 23 are fixed to each other.

The base member 21 and the wire-like transmission member 23 are fixed to each other by the contact area direct fixation. In this case, an outermost layer of the wire-like transmission member 23 and a fusion layer are fused to each other. The outermost layer of the wire-like transmission member 23 is the covering layer 25. The covering layer 25 is made up of a material which can be fused to the fusion layer. A resin material constituting the covering layer 25 and a resin material constituting the fusion layer may be the same type of material. A resin material constituting the fusion layer and a resin material constituting the covering layer 25 are PVC or polyolefin, for example.

The plurality of wire-like transmission members 23 are overlapped with the base member 21 in a part of a section, and are not overlapped with the base member 21 in the other part of the section. A section in the flat wiring member 20 in which the plurality of wire-like transmission members 23 are overlapped with the base member 21 is the first section S1. A section in the flat wiring member 20 in which the plurality of wire-like transmission members 23 extends outside the base member 21 is a second section S2. The first section S1 extends along the longitudinal direction (X direction) of the fixation target 90. As illustrated in FIG. 7, for example, the second section S2 is provided to an end part along the longitudinal direction of the first section S1. It is also applicable that the wire-like transmission member 23 is branched from an intermediate part along the longitudinal direction of the base member 21; thus, the second section S2 is provided to an intermediate part along a longitudinal direction of the first section S1.

As illustrated in FIG. 8, the flat wiring member 20 may have a multilayer structure that a plurality of wiring bodies 26 are stacked in the first section S1. Each of the plurality of wiring bodies 26 includes the base member 21 and the wire-like transmission member 23. The base members 21 of the plurality of wiring bodies 26 may be bonded in a bonding part to be kept in a stacked state. The bonding part may be made by fusion of the base members 21 or bonding using a fixing component different from the base member 21. FIG. 8 illustrates a fusion part FX2 where the base members 21 are fixed to each other. The fusion part FX2 is provided to a lateral side of the fusion part FX1.

In the example illustrated in FIG. 8, the wire-like transmission members 23 of the outermost two wiring bodies 26 are located closer to an inner side than the base member 21. Accordingly, the wire-like transmission members 23 in each layer are disposed between the outermost two base members 21 in the flat wiring member 20. The wire-like transmission member 23 of at least one of the outermost two wiring bodies 26 may be located closer to an outer side than the base member 21. In the example illustrated in FIG. 8, two wiring bodies 26 are stacked. Three or more wiring bodies 26 may be stacked.

As illustrated in FIG. 7, the base member 21 includes a fixing piece 22 fixed to the protector 40. The fixing piece 22 protrudes to a lateral side from a side edge of an arrangement body part of the base member 21 where the wire-like transmission member 23 is disposed. A slit 22S is formed in the fixing piece 22. The fixing piece 22 is provided to at least one base member 21 in the plurality of wiring bodies 26. The fixing piece 22 may be provided to the bonding part where the base members 21 are bonded to each other, or may also be provided separately from the bonding part.

The plurality of wire-like transmission members 23 extend to be divided into a plurality of groups for each connection destination different from each other in the second section S2. Herein, the plurality of groups include a first group G1, a second group G2, and a third group G3. The first group G1 and the second group G2 extend toward the same lateral side. The third group G3 extends toward a side opposite to the first group G1 and the second group G2. The first group G1 and the second group G2 extend toward one lateral side of the fixation target 90, and the third group G3 extends toward the other lateral side of the fixation target 90. The first group G1 is located between the second group G2 and the third group G3 in a base end of the second section S2. The plurality of wire-like transmission members 23 may be or may not be bundled by an adhesive tape, for example, in each of the groups G1, G2, and G3. Each diagram illustrates a state where the plurality of wire-like transmission members 23 are bundled in each of the groups G1, G2, and G3.

The first group G1, the second group G2, and the third group G3 extends along the longitudinal direction of the fixation target 90 from the first section S1. The first group G1 and the second group G2 are bended after extending from the first section S1, and extend toward one lateral side of the fixation target 90. The third group G3 is bended after extending from the first section S1, and extends toward the other lateral side of the fixation target 90. The first group G1 is bended at a side farther away from the first section S1 than the second group G2 along the longitudinal direction of the fixation target 90.

A way of dividing the plurality of wire-like transmission members 23 into the first group G1, the second group G2, and the third group G3 is not particularly limited, but can be appropriately set. When the first section S1 of the flat wiring member 20 has a multilayer structure that a plurality of wiring bodies 26 are stacked, one layer may include the plurality of groups of wire-like transmission members 23 together, for example. For example, the wire-like transmission members 23 may be divided into groups for each layer. That is to say, also applicable is a configuration that one group of wire-like transmission members 23 is provided to only one layer.

The plurality of connectors 27 include a first connector 27A, a second connector 27B, and a third connector 27C. The first connector 27A is provided to an end part of the first group G1. The second connector 27B is provided to an end part of the second group G2. The third connector 27C is provided to an end part of the third group G3. The connector 27 is connected to a counterpart connector.

As illustrated in FIG. 1, each connector 27 includes a connector housing CH, a lever RV, and a connector terminal not shown in the diagrams. The connector terminal is connected to the end part of the wire-like transmission member 23. The connector terminal is connected to a counterpart connector terminal of the counterpart connector while the connector 27 is connected to the counterpart connector. When the wire-like transmission member 23 is an electrical wire, the connector terminal is a conductor, and the connector housing CH is an insulating body.

The connector housing CH keeps the plurality of connector terminals in a predetermined arrangement. As illustrated in FIG. 1, a plurality of cavities CV are formed in the connector housing CH. The cavity CV is a through hole passing through a front surface and a back surface of the connector housing CH, for example. In the diagrams other than FIG. 1, illustration of the cavity CV is omitted. The wire-like transmission member 23 and the connector terminal are held in a predetermined cavity CV in the connector housing CH. The wire-like transmission member 23 extends from an opening part of the cavity CV in a back surface of the connector housing CH.

The lever RV is pivotably supported by a side surface of the connector housing CH. For example, the lever RV includes a pair of support pieces pivotably supported by a pair of side surfaces of the connector housing CH and a connection piece connecting the pair of support pieces. A rotation axis of the lever RV is located along a direction connecting the pair of side surfaces of the connector housing CH. The connector 27 is supported so that the rotation axis of the lever RV is directed along the X direction. The lever RV is pivoted when the connector 27 and the counterpart connector are fitted to each other. The lever RV is used for making a transition to the fitting of the connector 27 and the counterpart connector or maintaining a fitting state thereof.

### <Wire-Like Member>

The wire-like member 30 is provided separately from the flat wiring member 20. The wire-like member 30 may be a member transmitting electricity or light in the manner similar to the wire-like transmission member 23 in the flat wiring member 20. The wire-like member 30 may be a hose for flowing a fluid. One or a plurality of wire-like members 30 may be provided. An end part of the wire-like member 30 may be connected to the same connection destination as the flat wiring member 20, or may also be connected to a connection destination different from that of the flat wiring member 20.

Herein, an intermediate part of the wire-like member 30 along an extension direction is fixed to the protector 40. A fixing member 32 is provided to the wire-like member 30. The fixing member 32 is a member for fixing the wire-like member 30 to the protector 40. Herein, the fixing member 32 includes a fixing part 33 and an attachment plate part 34.

The fixing part 33 is a part fixed to the protector 40. Wire material fixing parts 60 and 76 to which the fixing part 33 is fixed are provided to the protector 40. A clamp is provided as the fixing part 33 herein. A locking hole to which the clamp is locked is formed in the wire material fixing parts 60 and 76. The clamp includes a columnar part and a locking piece protruding from the columnar part. When the clamp is inserted into the locking hole, the locking piece has contact with a peripheral edge of the locking hole, thereby being able to be elastically deformed so that a width of the locking piece is reduced. The clamp can thereby pass through the locking hole. After the clamp passes through the locking hole, the locking piece is elastically restored to be locked to the peripheral edge of the locking hole. Accordingly, the fixing member 32 is fixed to the protector 40.

The attachment plate part 34 is a part for attaching the fixing member 32 to the wire-like member 30. Herein, the attachment plate part 34 is formed into a plate-like shape extending along the wire-like member 30. As illustrated in FIG. 5, for example, a banding member such as an adhesive tape 36 is wound around the attachment plate part 34 and the wire-like member 30 to attach the fixing member 32 to the wire-like member 30.

Herein, the wire-like member 30 is a bendable member, and is held in a bended state by the attachment plate part 34. Specifically, the attachment plate part 34 is formed into an L-like planar shape. The attachment plate part 34 includes a first plate part and a second plate part intersecting with each other. Each of the first plate part and the second plate part is banded with the wire-like member 30. Accordingly, a route of a part of the wire-like member 30 provided with the fixing member 32 is regulated to extend to have an L-like shape. The fixing part 33 is provided to a connection part where the first plate part and the second plate part are connected. The attachment plate part 34 may be formed straight to regulate the route of the wire-like member 30 straight.

Herein, the fixing member 32 is provided in two positions at intervals along the extension direction of the wire-like member 30. The route of the wire-like member 30 is regulated to extend to have the L-like shape in each of the positions of two fixing members 32.

### <Protector>

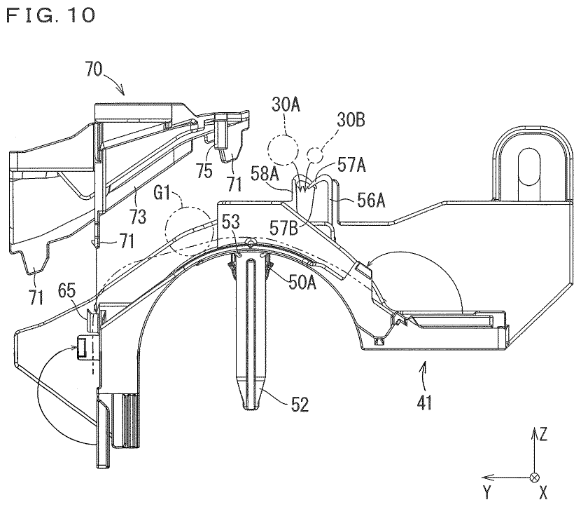

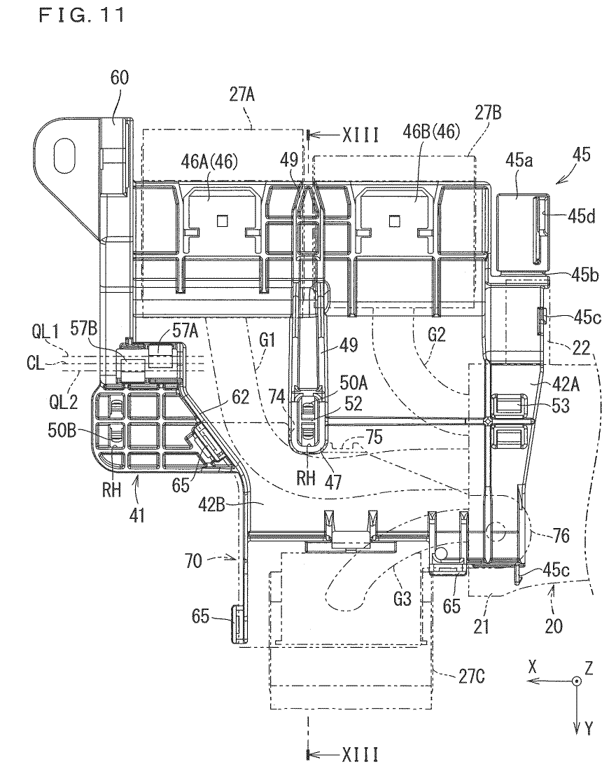

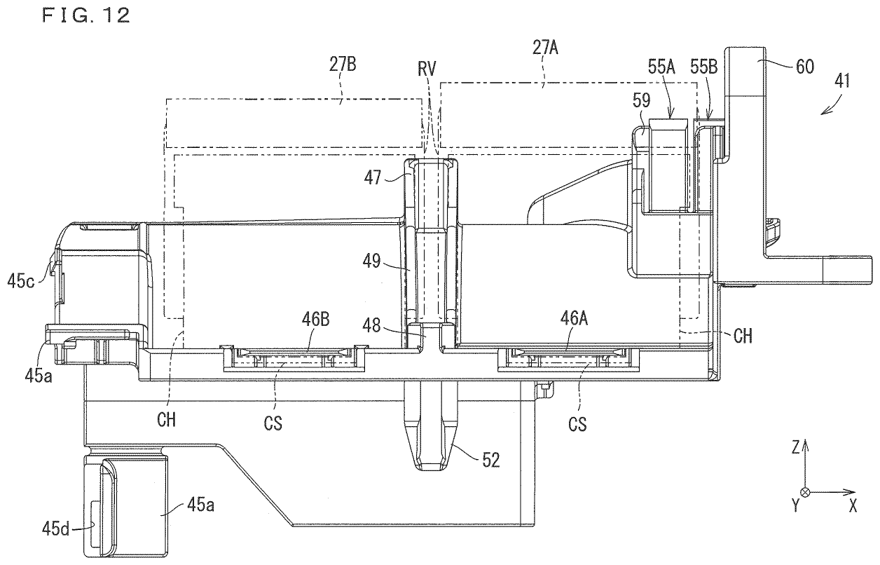

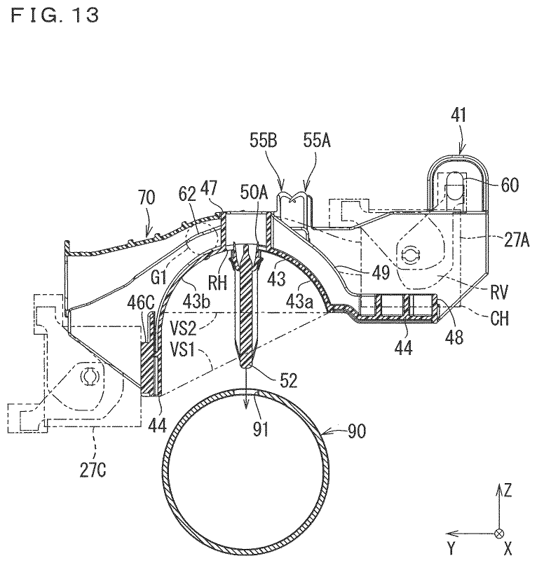

The protector 40 is further described with reference to FIG. 9 to FIG. 13 in addition to FIG. 1 to FIG. 8. FIG. 9 is a front view illustrating a protector body 41 and a cover 70. FIG. 10 is a back view illustrating the protector body 41 and the cover 70. FIG. 11 is a plan view illustrating the protector body 41. FIG. 12 is a side view illustrating the protector body 41. FIG. 13 is a cross-sectional view of the protector 40 along a XIII-XIII line in FIG. 11. The protector 40 is provided in an end part of the flat wiring member 20. The protector 40 supports an end part of the first section S1 and the second section S2. The protector 40 does not support an intermediate part of the first section S1. Accordingly, the first section S1 includes a section supported by the protector 40 and a section not supported by the protector 40.

The protector 40 includes a first holding part for holding the flat wiring member 20, an attachment part for being attached to the fixation target 90, and a second holding part for holding the wire-like member 30. Herein, the protector 40 includes the protector body 41 and the cover 70 provided separately from the protector body 41. The protector body 41 and the cover 70 are molded differently from each other. The cover 70 includes a locking part 71, and the protector body 41 includes a receiving part 65. When the locking part 71 is fitted to the receiving part 65, the protector body 41 and the cover 70 are incorporated with each other. Each part of the first holding part, the attachment part, and the second holding part is provided to the protector body 41 or the cover 70.

### <First Holding Part>

The protector 40 includes a support part 42, a partition convex part 47, and a guide convex part 48 as the first holding part for holding the flat wiring member 20.

The support part 42 supports the flat wiring member 20. As illustrated in FIG. 13, the support part 42 includes a support body 43 and a pair of extension parts 44. The support body 43 extends over the fixation target 90. The support body 43 is formed into a shape corresponding to an outer shape of the fixation target 90. Herein, an outer shape of the support body 43 is formed into a cylindrical shape partially opened in a circumferential direction in accordance with the circular fixation target 90. The support body 43 is formed into a semicylindrical shape made by dividing a cylindrical member in half along an axial direction. One of the pair of extension parts 44 extends from one end of the support body 43, and the other one thereof extends from the other end of the support body 43. Herein, one extension part 44 extends from one end of the support body 43 along a radial direction of the fixation target 90. The other extension part 44 extends from the other end of the support body 43 along a tangential direction of the fixation target 90. The extension part 44 may extend in a direction different from the radial direction and the tangential direction of the fixation target 90.

The support part 42 includes a first support part 42A and a second support part 42B. The first support part 42A supports the first section S1. The second support part 42B is continuously formed with the first support part 42A to support the second section S2. Herein, one end side of the support part 42 along the longitudinal direction of the fixation target 90 is the first support part 42A, and the other end side thereof is the second support part 42B.

The end part of the first section S1 is supported on the support part 42. The protector 40 holds the base member 21 in the first section S1. The protector 40 includes a base holding part 45 provided to the first support part 42A to hold the base member 21. Herein, the base holding part 45 is provided to each of the pair of extension parts 44. As illustrated in FIG. 11, the base holding part 45 includes a sandwiching plate part 45a, a hinge part 45b, a locking protrusion 45c, and a locking hole 45d. The sandwiching plate part 45a is continuously formed with the extension part 44 via the hinge part 45b. The sandwiching plate part 45a is pivotably connected to the extension part 44 by the hinge part 45b. The locking protrusion 45c protrudes from a main surface of the extension part 44.

The locking hole 45d is formed in the sandwiching plate part 45a. A through hole through which the locking protrusion 45c passes is formed in the base member 21. The locking protrusion 45c passes through the through hole to be locked to the locking hole 45d while the base member 21 is sandwiched between the sandwiching plate part 45a and the extension part 44. Accordingly, the base member 21 is kept in a state of being sandwiched between the sandwiching plate part 45a and the extension part 44.

Each of the groups G1, G2, and G3 extends on the support part 42 in the second section S2. The connector 27 is held by the protector 40 in the second section S2. The protector 40 includes a connector holding part 46 provided to the second support part 42B to hold the connector 27. The connector holding part 46 is provided to the extension part 44 in the protector body 41. As illustrated in FIG. 11, for example, the connector holding part 46 is formed into a slot-like shape. A cassette part CS is provided to a lower surface of the connector housing CH. The connector holding part 46 is inserted into the cassette part CS of the connector 27, and is locked thereto. The cassette part CS of the connector 27 is inserted into the connector holding part 46 along an axial direction of the cavity CV.

The protector 40 includes a first connector holding part 46A holding the first connector 27A, a second connector holding part 46B holding the second connector 27B, and a third connector holding part 46C holding the third connector 27C. The first connector holding part 46A and the second connector holding part 46B are provided to one of the pair of extension parts 44, and the third connector holding part 46C is provided to the other one thereof. Each of the groups G1, G2, and G3 extends from an end edge of the base member 21 to be directed to the corresponding connector holding part 46. The first connector holding part 46A and the second connector holding part 46B are arranged along the longitudinal direction of the fixation target 90. The first connector holding part 46A and the second connector holding part 46B hold the first connector 27A and the second connector 27B so that the axial direction of the cavity CV extends along a horizontal direction. The third connector holding part 46C holds the third connector 27C so that the axial direction of the cavity CV extends along a vertical direction.

The connector 27 is moved along the axial direction of the cavity CV, and the cassette part CS is inserted into the connector holding part 46. In the first connector holding part 46A and the second connector holding part 46B, the first connector 27A and the second connector 27B are moved in a Y direction, and the cassette part CS is inserted into the connector holding part 46. In the third connector holding part 46C, the third connector 27C is moved in a Z direction, and the cassette part CS is inserted into the connector holding part 46. The connector housing CH gets close to the connector holding part 46 from a back end from which the wire-like transmission member 23 extends.

The partition convex part 47 is provided to the second support part 42B. The partition convex part 47 partitions the plurality of groups. As illustrated in FIG. 11, the partition convex part 47 partitions the first group G1 and the second group G2 herein. A bending part of the first group G1 is located on a side farther away from the first section S1 than the partition convex part 47. A bending part of the second group G2 is located on a side closer to the first section S1 than the partition convex part 47. The first group G1 extends from the base member 21 in the X direction, and then extends over the partition convex part 47 to be bended in one lateral side. The second group G2 extends from the base member 21, and is then bended in one lateral side without extending over the partition convex part 47.

The partition convex part 47 protrudes to an upper side from the support body 43 of the support part 42. A protrusion dimension of the partition convex part 47 is not particularly limited, but may be equal to or larger than a diameter of the first group G1 bundled into a circular shape, for example.

The guide convex part 48 is located between the first connector holding part 46A and the second connector holding part 46B. As illustrated in FIG. 12, the guide convex part 48 is provided between the side surfaces of the connector housing CH to suppress contact of the levers RV. The guide convex part 48 is located on a lateral side of a lower part of the side surface of the connector housing CH. An attachment piece of the lever RV is located above the guide convex part 48.

In a parallel direction of the first connector 27A and the second connector 27B, a dimension of the guide convex part 48 is larger than twice the protrusion dimension of the lever RV from the side surface of the connector housing CH in one connector 27. Applied is a configuration that even when the side surfaces of two connector housings CH have contact with the guide convex part 48, the levers RV do not have contact with each other.

The guide convex part 48 is formed into a tapered shape gradually tapered toward a front side of an insertion direction of the cassette part CS. Accordingly, when the cassette part CS of the connector 27 is inserted into the connector holding part 46, a back part of the connector housing CH is guided by a distal end of the guide convex part 48. The guide convex part 48 is formed into a rib-like shape with two bars arranged at an interval in the X direction. The interval of the rib with two bars gradually decreases toward a front side of the insertion direction, and the rib with two bars are connected to each other at a foremost side.

The guide convex part 48 and the partition convex part 47 are connected to each other. A connection convex part 49 extends from the partition convex part 47 toward one lateral side of the fixation target 90, and the guide convex part 48 is provided to an end part of the connection convex part 49. The connection convex part 49 and the partition convex part 47 are also formed into a rib-like shape with two bars in the manner similar to the guide convex part 48. The rib with two bars extends in the X direction and connected to each other in the partition convex part 47. It is also applicable that the connection convex part 49 is not provided and the guide convex part 48 and the partition convex part 47 are not connected to each other.

The third connector holding part 46C supports the third connector 27C so that an opening part of the cavity CV is directed upward. The cover 70 covers above the opening part of the cavity CV of the third connector 27C. Accordingly, intrusion of water into the cavity CV of the third connector 27C can be suppressed. Accordingly, splash of water to a connector terminal of the third connector 27C can be suppressed.

The cover 70 includes a part covering the first section S1 of the flat wiring member 20 to suppress intrusion of water into the cavity CV of the third connector 27C more easily. The cover 70 covers the first section S1 between the base holding parts 45 on both sides. A base end of the third group G3 extending from the first section S1 is covered by the cover 70. The cover 70 covers almost the whole upper side of the third group G3. Accordingly, splash of water to the third group G3 is suppressed at a position away from the cavity CV. Accordingly, intrusion of water splashing on the third group G3 at the position away from the cavity CV and spilling down the wire-like transmission member 23 of the third group G3 into the cavity CV can be suppressed.

A downward wall 73 is provided to the cover 70 to suppress intrusion of water into the cavity CV of the third connector 27C more easily. The downward wall 73 protrudes downward from an end edge of the cover 70 along the longitudinal direction of the fixation target 90. The downward wall 73 is overlapped with a partition wall 62 of the protector body 41 along the longitudinal direction of the fixation target 90. The downward wall 73 is located on the outer side than the partition wall 62 along the longitudinal direction of the fixation target 90. A part where the downward wall 73 and the partition wall 62 are overlapped with each other functions as a labyrinth structure for suppressing intrusion of water from the end edge of the cover 70.

Two locking parts 71 are provided to the downward wall 73. As illustrated in FIG. 9, two locking parts 71 are provided to both ends of the downward wall 73. Since two locking parts 71 are locked to the receiving part 65, an overlapping state of the downward wall 73 and the partition wall 62 is easily maintained. The other one locking part 71 is provided between a part covering the first section S1 and a part covering the third connector 27C in the cover 70.

The cover 70 does not cover the first connector 27A and the second connector 27B. Herein, the first connector 27A and the second connector 27B are supported so that the opening of the cavity CV is directed to the horizontal direction. Thus, even when the cover 70 does not cover the first connector 27A and the second connector 27B, intrusion of water into the cavity CV of each of the first connector 27A and the second connector 27B and splash of water to the connector terminal hardly occur. For the similar reason, the cover 70 does not also cover the whole second group G2 and a part of the first group G1.

The cover 70 covers the other part of the first group G1. The cover 70 covers an intermediate part of the first group G1 located around the partition convex part 47. This configuration is applied to easily maintain a partition state of the first group G1 and the second group G2. Furthermore, a fitting concave part 74 (refer to FIG. 6) and a press wall 75 (refer to FIG. 10) are provided to the cover 70 to easily maintain the partition state of the first group G1 and the second group G2.

The fitting concave part 74 is formed in a side edge of the cover 70. An upper part of the partition convex part 47 is fitted to the fitting concave part 74. Since the partition convex part 47 is fitted to the fitting concave part 74, a gap between the side edge of the cover 70 and the partition convex part 47 is reduced. Accordingly, entering of the wire-like transmission member 23 of the first group G1 into the gap can be suppressed. Since the partition convex part 47 is fitted to the fitting concave part 74, the cover 70 and the protector body 41 can be positioned. The locking part 71 on one end of the downward wall 73 is located on an opposite side of the fitting concave part 74.

The press wall 75 protrudes downward from the side edge of the cover 70. The press wall 75 is located closer to the first section S1 in relation to the fitting concave part 74. The press wall 75 presses a lateral side of the first group G1 at a side closer to the first section S1 in relation to the partition convex part 47. Accordingly, arrangement of the first group G1 closer to the second connector 27B in relation to the press wall 75 can be suppressed.

### <Attachment Part>

The protector 40 includes a fixing part 50, an insertion part 52, and a plate spring 53 as attachment parts for being attached to the fixation target 90. The fixing part 50, the insertion part 52, and the plate spring 53 protrude from a surface of the support body 43 on a side opposite to a surface thereof supporting the flat wiring member 20. The fixing part 50, the insertion part 52, and the plate spring 53 protrude to the same side as each other with respect to the support part 42.

The fixing part 50 is a part fixed to the fixation target 90. The fixing part 50 includes a first fixing part 50A and a second fixing part 50B. The first fixing part 50A and the second fixing part 50B are located away from each other at an interval in the X direction. The first fixing part 50A is fixed to the first fixing hole 91. The second fixing part 50B is fixed to the second fixing hole 92. Herein, the fixing part 50 is a clamp including a columnar part and a locking piece protruding from the columnar part in the manner similar to the fixing part 33 of the fixing member 32.

The first fixing part 50A is provided to the second support part 42B. The first fixing part 50A and the partition convex part 47 protrude to sides opposite to each other from the same position in the second support part 42B. A release hole RH for releasing the fixing state of the first fixing part 50A fixed to the first fixing hole 91 is formed in the partition convex part 47. Herein, a base end of the columnar part of the clamp and the release hole RH are located in a part surrounded by the ribs of the partition convex part 47. It is possible to have access to the locking piece of the clamp and deform the locking piece to reduce a width thereof through the release hole RH. A distal end of the locking piece of the clamp may protrude to an upper side than an upper surface of the support body 43.

The release hole RH is also formed in a position of the second fixing part 50B. The flat wiring member 20 does not cover the release hole RH of the second fixing part 50B. Accordingly, the second fixing part 50B can be easily released through the release hole RH. Applied is a configuration that the wire-like transmission member 23 of the flat wiring member 20 does not extend to a side of the second fixing part 50B. The second fixing part 50B is located farther away from the first section S1 than the first fixing part 50A. The partition wall 62 is formed between a part to which the second fixing part 50B is provided and the partition convex part 47 in the protector 40. Since the partition wall 62 is provided, suppressed is extension of the wire-like transmission member 23 of the first group G1 closer to the second fixing part 50B in relation to the partition wall 62. The receiving part 65 is provided to a part of the partition wall 62 located between the first fixing part 50A and the second fixing part 50B. The cover 70 covers a part of the wire-like transmission member 23 of the first group G1 located between the partition wall 62 and the partition convex part 47.

The insertion part 52 is a part inserted into the fixation target 90 in advance of the fixing part 50. The insertion part 52 is longer than the fixing part 50. The first fixing part 50A and the second fixing part 50B are shorter than the insertion part 52. An amount of protrusion of the insertion part 52 from the support body 43 is larger than that of the fixing part 50 from the support body 43. Since the insertion part 52 is inserted into the fixation target 90, the fixing part 50 before fixation can be positioned with respect to the fixation target 90. A distal end of the insertion part 52 is formed into a tapered shape. Accordingly, the insertion part 52 is easily inserted into the fixation target 90.

Herein, the insertion part 52 is provided in a position of the first fixing part 50A. The first fixing part 50A is provided to a base end of the insertion part 52. The insertion part 52 protrudes from a distal end of the columnar part of the first fixing part 50A. The insertion part 52 is inserted into the first fixing hole 91 to which the first fixing part 50A is fixed. In the fixation target 90, one hole (the first fixing hole 91) may be used as a hole for inserting the insertion part or a hole for fixing the first fixing part 50A. Accordingly, increase in the number of holes in the fixation target 90 can be suppressed. Since the insertion part 52 is provided in the position of the first fixing part 50A, the insertion part 52 is provided to a side opposite to the partition convex part 47.

A protrusion dimension of the insertion part 52 can be appropriately set within a range longer than the fixing part 50. For example, a dimension from the support part 42 to the distal end of the insertion part 52 may be twice or more a dimension from the support part 42 to the distal end of the first fixing part 50A.

The support part 42 includes a first inward surface 43a and a second inward surface 43b. A part of the support part 42 continuously formed with the base end of the insertion part 52 is a connection part. Herein, the connection part is a part continuously formed with a base end of the partition convex part 47. The first inward surface 43a extends to one lateral side of the fixation target 90 from the connection part to face the fixation target 90. The second inward surface 43b extends to the other lateral side of the fixation target 90 from the connection part to face the fixation target 90.

A reference surface VS1 illustrated in FIG. 13 is a virtual surface made by continuous occurrence of a line connecting a distal end of the first inward surface 43a and a distal end of the second inward surface 43b in the longitudinal direction of the fixation target 90. As illustrated in FIG. 13, a length of the insertion part 52 may be set so that the distal end of the insertion part 52 goes over the reference surface VS1.

A reference surface different from the reference surface VS1 may be set as the reference surface.

For example, a reference surface VS2 illustrated in FIG. 13 may be set as the reference surface. The reference surface VS2 is a virtual surface passing through the distal end of the inward surface 43a to be perpendicular to a protrusion direction of the insertion part 52. As illustrated in FIG. 13, a length of the insertion part 52 may be set so that the distal end of the insertion part 52 goes over the reference surface VS2. The inward surface 43a with respect to the reference surface VS2 is a surface equal to or shorter than the other inward surface 43b. That is to say, the dimension from the connection part to the distal end of the inward surface 43a is equal to or shorter than that from the connection part to the distal end of the other inward surface 43b.

For example, a reference surface VS3 illustrated in FIG. 3 may be set as the reference surface. The reference surface VS3 is a virtual surface passing through a center axis of the fixation target 90 to be perpendicular to the protrusion direction of the insertion part 52. As illustrated in FIG. 3, the length of the insertion part 52 may be set so that the distal end of the insertion part 52 goes over the reference surface VS3.

It is sufficient that an upper limit of the length of the insertion part 52 is set to a length so that the distal end of the insertion part 52 is located inside the cylindrical fixation target 90. That is to say, it is sufficient that the distal end of the insertion part 52 does not pass through an outer surface of the fixation target 90 on a side opposite to the first fixing hole 91 so as not to protrude outside the outer surface of the fixation target 90. For example, when the outer surface of the fixation target 90 has a circular shape, the length of the insertion part 52 may be equal to or smaller than a diameter of the outer surface of the fixation target 90. The distal end of the insertion part 52 may pass through the fixation target 90 on a side opposite to the first fixing hole 91.

The plate spring 53 is pressed against the fixation target 90. Since the plate spring 53 is warped when the fixing part 50 is fixed to the fixing holes 91 and 92, a slip of the protector 40 is suppressed. The plate spring 53 may be omitted. The plate spring 53 is a notched part in which a part of the support body 43 protrudes below the other part of the support body 43. The plate spring 53 is shorter than the fixing part 50 in the Z direction. The plate spring 53 is provided to the first support part 42A. The plate spring 53 is covered by the first section S1. Differing from the fixing part 50, the plate spring 53 needs not be operated by a worker for a release operation. Thus, even when the plate spring 53 is covered by the flat wiring member 20, deterioration of operability does not occur in detaching the protector 40 from the fixation target 90.

The first fixing part 50A, the second fixing part 50B, and the plate spring 53 are provided away from each other along the longitudinal direction of the fixation target 90. An order of the first fixing part 50A, the second fixing part 50B, and the plate spring 53 is not particularly limited, but can be appropriately set. Herein, the second fixing part 50B is provided on an opposite side of the first fixing part 50A from the plate spring 53 in the X direction. That is to say, the first fixing part 50A is located between the second fixing part 50B and the plate spring 53. The second fixing part 50B may be located between the first fixing part 50A and the plate spring 53. The plate spring 53 may be located between the first fixing part 50A and the second fixing part 50B.

### <Second Holding Part>

The protector 40 includes a wire material holding part 54 and the wire material fixing parts 60 and 76 as the second holding part for holding the wire-like member 30. The wire material holding part 54 holds the wire-like member 30. The wire material fixing parts 60 and 76 are parts to which the wire-like member 30 is fixed in positions different from the wire material holding part 54. The wire material fixing part 60 and 76 include a first wire material fixing part 60 and a second wire material fixing part 76.

The wire material holding part 54 includes a first nail part 55A and a second nail part 55B arranged along the extension direction (the X direction herein) of the wire-like member 30 held by the wire material holding part 54. Only the first nail part 55A and the second nail part 55B are provided as nail parts in one wire material holding part 54.

The first nail part 55A includes a first sidewall 56A and a first press piece 57A. The first sidewall 56A covers one lateral side of the wire-like member 30. The first press piece 57A protrudes from the first sidewall 56A. The first press piece 57A extends toward the other lateral side of the wire-like member 30.

The second nail part 55B includes a second sidewall 56B and a second press piece 57B. The second sidewall 56B covers the other lateral side of the wire-like member 30. The first sidewall 56A and the second sidewall 56B are provided away from each other in the Y direction. The second press piece 57B protrudes from the second sidewall 56B. The second press piece 57B extends toward the one lateral side of the wire-like member 30.

The first press piece 57A and the second press piece 57B are located away from each other along the X direction. An interval between the first press piece 57A and the second press piece 57B can be appropriately set. For example, the interval between the first press piece 57A and the second press piece 57B may be equal to or smaller than a dimension of each of the press pieces 57A and 57B in the X direction. In the example illustrated in FIG. 11, the interval between the first press piece 57A and the second press piece 57B is smaller than the dimension of each of the press pieces 57A and 57B in the X direction.

A distal end of the first press piece 57A and a distal end of the second press piece 57B face each other along the X direction. As illustrated in FIG. 9, the distal end of the first press piece 57A and the distal end of the second press piece 57B intersect with each other when seen from the X direction to have an X-like shape herein. The distal end of the first press piece 57A and the distal end of the second press piece 57B may have a V-like shape or a T-like shape when seen from the X direction.

As illustrated in FIG. 10, the first nail part 55A includes a first facing wall 58A facing the first sidewall 56A. As illustrated in FIG. 9, the second nail part 55B includes a second facing wall 58B facing the second sidewall 56B. In each of the nail parts 55A and 55B, the wire-like member 30 is inserted from an upper opening between the sidewalls 56A and 56B and the facing walls 58A and 58B. In each of the nail parts 55A and 55B, the press pieces 57A and 57B narrow the upper opening between the sidewalls 56A and 56B and the facing walls 58A and 58B. The press piece pressing the wire-like member 30 or the protrusion is not provided to an inner surface of each of the facing walls 58A and 58B facing a side of the wire-like member 30. A reinforcement rib is provided to an outer surface of each of the facing walls 58A and 58B on a side opposite to the inner surface thereof.

As illustrated in FIG. 4, the first sidewall 56A and the second facing wall 58B are located away from each other along the X direction. That is to say, a slit is formed between the first sidewall 56A and the second facing wall 58B. In the similar manner, the second sidewall 56B and the first facing wall 58A are located away from each other along the X direction. A slit is also formed between the second sidewall 56B and the first facing wall 58A. Accordingly, the first nail part 55A and the second nail part 55B are easily deformed when the wire-like member 30 is inserted.

As illustrated in FIG. 5, a guide surface 59 inclined inward from a distal end of the second facing wall 58B toward a base end thereof is formed in the inner surface of the second facing wall 58B. The similar guide surface 59 is also formed in the inner surface of the first facing wall 58A. The guide surface is also formed in an outer surface (upper surface) of the first press piece 57A and an outer surface (upper surface) of the second press piece 57B. A region between the base end of the sidewalls 56A and 56B and the base end of the facing walls 58A and 58B are notched at positions of the nail parts 55A and 55B, and there is no bottom part. A bottom part of the wire material holding part 54 is located outside the nail parts 55A and 55B along the X direction.

As illustrated in FIG. 11, a virtual line extending along the extension direction through a center between the first sidewall 56A and the second sidewall 56B is a center line CL. The distal end of the first press piece 57A extends over the center line CL to be located on a side of the second sidewall 56B. The distal end of the second press piece 57B extends over the center line CL to be located on a side of the first sidewall 56A.

As illustrated in FIG. 11, a virtual line extending along the center line CL through a center between the center line CL and the first sidewall 56A is a first quarter line QL1, and a virtual line extending along the center line CL through a center between the center line CL and the second sidewall 56B is a second quarter line QL2. The distal line of the first press piece 57A does not extend over the second quarter line. The distal line of the second press piece 57B does not extend over the first quarter line. Accordingly, a gap between the first nail part 55A and the first facing wall 58A and a gap between the second nail part 55B and the second facing wall 58B can get large, and the thick wire-like member 30A can easily enter the gap.

In FIG. 9, a virtual line L1 shows a position of the inner surface of the first sidewall 56A. A virtual line L2 shows a position of the inner surface of the second sidewall 56B. A virtual line L3 shows a position of the center line CL. A virtual line L4 shows a position of the first quarter line QL1. A virtual line L4 shows a position of the second quarter line QL2.

Each of the nail parts 55A and 55B is elastically deformed so that the upper opening substantially as large as the diameter of the wire-like member 30 upon receiving force of pressing the wire-like member 30 in the gap when the wire-like member 30 is inserted from the upper opening. Each of the nail parts 55A and 55B is elastically restored after the wire-like member 30 is inserted, and the upper opening gets smaller than the diameter of the wire-like member 30.

A size of the wire-like member 30 may be different in accordance with a type or a grade of a vehicle. For example, as illustrated in FIG. 10, there is a possibility that a thick wire-like member 30A having the same diameter as a dimension of the interval between the sidewalls 56A and 56B and the facing walls 58A and 58B is inserted into the wire material holding part 54. For example, there is a possibility that a thin wire-like member 30B having the same diameter as a dimension of half the interval between the sidewalls 56A and 56B and the facing walls 58A and 58B is inserted into the wire material holding part 54. Since two nail parts 55A and 55B are provided in positions offset in the extension direction (X direction) of the wire-like member 30 herein, the wire-like member 30A and 30B having the different sizes can also be easily held by the wire material holding part 54.

The wire material holding part 54 is located between the first wire material fixing part 60 and the second wire material fixing part 76 along the extension direction of the wire-like member 30. Herein, the first wire material fixing part 60 and the second wire material fixing part 76 are located away in the X direction and the Y direction, respectively. The wire material holding part 54 is located between the first wire material fixing part 60 and the second wire material fixing part 76 in each of the X direction and the Y direction.

A part of the wire-like member 30 ranging from the wire material holding part 54 to the first wire material fixing part 60 and a part thereof ranging from the wire material holding part 54 to the second wire material fixing part 76 are bended in directions opposite to each other. Accordingly, the wire-like member 30 can be held along a route having an S-like shape using the wire material holding part 54, the first wire material fixing part 60, and the second wire material fixing part 76. An object of holding the wire-like member 30 along the route having the S-like shape may be to regulate the route of the wire-like member 30 to suppress interference between the wire-like member 30 and a surrounding member, for example. For example, the route may be regulated to suppress a bending radius of the wire-like member 30 to be smaller than a minimum bending radius. For example, a redundant length may be absorbed because the route of the wire-like member 30 gets longer in accordance with such a configuration compared with a case where the first wire material fixing part 60 and the second wire material fixing part 76 extend along a shortest route.

Herein, the wire material holding part 54 is located in substantially the same position as the second fixing part 50B in the X direction, and is located between the second fixing part 50B and the second wire material fixing part 76 in the Y direction. Suppressed accordingly is an overlap between the wire-like member 30 and the release hole RH of the second fixing part 50B in a plan view.

Herein, the wire-like member 30 is bended to a side of the first facing wall 58A from the first nail part 55A toward the first wire material fixing part 60. The wire-like member 30 is bended to a side of the second facing wall 58B from the second nail part 55B toward the second wire material fixing part 76. The wire-like member 30 may be bended to a side of the first sidewall 56A from the first nail part 55A toward the first wire material fixing part 60. The wire-like member 30 may be bended to a side of the second sidewall 56B from the second nail part 55B toward the second wire material fixing part 76.

Herein, the first wire material fixing part 60 is provided to the protector body 41, and the second wire material fixing part 76 is provided to the cover 70. Both the first wire material fixing part 60 and the second wire material fixing part 76 may be provided to one of the protector 40 and the cover 70. Since the second wire material fixing part 76 is provided to the cover 70, the cover 70 is pressed downward from the wire-like member 30 at a position of the second wire material fixing part 76. Suppressed accordingly is detachment of the cover 70.

### <Effect Etc.>

According to the wiring module 10 having the above configuration, the protrusion dimension of the insertion part 52 is larger than that of the fixing part 50. Accordingly, the insertion part 52 can be elongated. Thus, the insertion part 52 can be visually recognized easily, or the distal end of the insertion part 52 can be easily positioned to the hole 91 in the fixation target 90. Accordingly, attachment operability of the wiring module 10 can be improved.

When the virtual surface made by the continuous occurrence of the line connecting the distal end of the first inward surface 43a and the distal end of the second inward surface 43b in the longitudinal direction of the fixation target 90 is the reference surface VS1, the distal end of the insertion part 52 goes over the reference surface VS1. Accordingly, the insertion part 52 can be longer than the line connecting the distal end of the first inward surface 43a and the distal end of the second inward surface 43b when seen from the direction along the longitudinal direction of the fixation target 90.

In the case where the virtual surface passing through the distal end of the first inward surface 43a to be perpendicular to the protrusion direction of the insertion part 52 is the reference surface VS2, when the distal end of the insertion part 52 goes over the reference surface VS2, the insertion part 52 can be longer than the first inward surface 43a.

In the case where the virtual surface passing through the center axis of the fixation target 90 to be perpendicular to the protrusion direction of the insertion part 52 is the reference surface VS3, when the distal end of the insertion part 52 goes over the reference surface VS3, the insertion part 52 can be longer than the center axis of the fixation target 90.

The fixing part 50 includes the first fixing part 50A provided to the base end of the insertion part 52 to be fixed to the first fixing hole 91 into which the insertion part 52 is inserted in the fixation target 90. Accordingly, the protector 40 can be fixed to the fixation target 90 at the position of the insertion part 52.

Since the fixing part 50 includes the first fixing part 50A and the second fixing part 50B, the protector 40 can be fixed to the fixation target 90 at the plurality of positions. Since the second fixing part 50B is shorter than the insertion part 52, the insertion part 52 is inserted into the first fixing hole 91 in advance of the first fixing part 50A and the second fixing part 50B. Accordingly, the first fixing part 50A and the second fixing part 50B before fixation can be positioned with respect to the fixation target 90.

The first fixing part 50A, the second fixing part 50B, and the plate spring 53 are provided away from each other along the longitudinal direction of the fixation target 90. The slip of the protector 40 with respect to the fixation target 90 can be easily suppressed by fixation at the plurality of positions using the first fixing part 50A and the second fixing part 50B and the plate spring 53.

The partition convex part 47 and the insertion part 52 protrude to the sides opposite to each other from the same position in the support part 42. Accordingly, when the protector 40 is seen from the surface to which the partition convex part 47 is provided, the position of the insertion part 52 can be easily grasped based on the position of the partition convex part 47.

Since the first fixing part 50A is provided to the base end of the insertion part 52, the protector 40 can be fixed to the fixation target 90 at the position of the insertion part 52. Since the insertion part 52 is inserted into the first fixing hole 91 in advance of the first fixing part 50A, the first fixing part 50A before fixation can be easily positioned to the fixation target 90. Since the release hole RH is formed in the partition convex part 47, the position of the release hole RH is easily grasped based on the position of the partition convex part 47. Since the plurality of groups G1 and G2 are partitioned by the partition convex part 47, suppressed is the wire-like transmission members 23 of the groups G1 and G2 covering the release hole RH.

### APPENDIX

In the above description, the support part 42 supports both the first section S1 and the second section S2, however, this configuration is not necessary. The support part 42 may support only one of the first section S1 and the second section S2. For example, applicable is a configuration that the protector 40 is provided to the intermediate part of the first section S1 in the extension direction, and the support part 42 supports only the first section S1.

The configurations described in the embodiments and modification examples thereof can be appropriately combined as long as they are not contradictory.

While the disclosure has been shown and described in detail, the foregoing description is in all aspects illustrative and not restrictive. It is therefore understood that numerous modifications and variations can be devised.

What is claimed is:

1. A wiring module attached to a fixation target elongated on one side, comprising:
a flat wiring member extending along an elongated direction of the fixation target; and
a protector attaching the flat wiring member to the fixation target, wherein
the protector includes a support part supporting the flat wiring member and a fixing part and an insertion part each protruding from the support part to a side opposite to a side on which the flat wiring member is supported, and
a protrusion dimension of the insertion part is larger than a protrusion dimension of the fixing part.

2. The wiring module according to claim 1, wherein
the support part includes a first inward surface extending to one lateral side of the fixation target from a connection part continuously formed with a base end of the insertion part to face the fixation target and a second inward surface extending to another lateral side of the fixation target from the connection part to face the fixation target, and
when a virtual surface made by continuous occurrence of a line connecting a distal end of the first inward surface and a distal end of the second inward surface in a longitudinal direction of the fixation target is a reference surface, a distal end of the insertion part goes over the reference surface.

3. The wiring module according to claim 1, wherein
the support part includes a first inward surface extending to one lateral side of the fixation target from a connection part continuously formed with a base end of the insertion part to face the fixation target and a second inward surface extending to another lateral side of the fixation target from the connection part to face the fixation target,
a dimension from the insertion part to a distal end of the first inward surface is equal to or smaller than a dimension from the insertion part to a distal end of the second inward direction, and
when a virtual surface passing through the distal end of the first inward surface to be perpendicular to a protrusion direction of the insertion part is a reference surface, a distal end of the insertion part goes over the reference surface.

4. The wiring module according to claim 1, wherein
when a virtual surface passing through a center axis of the fixation target to be perpendicular to a protrusion direction of the insertion part is a reference surface, a distal end of the insertion part goes over the reference surface.

5. The wiring module according to claim 1, wherein
the fixing part includes a first fixing part provided to a base end of the insertion part to be fixed to a first fixing hole into which the insertion hole is inserted in the fixation target.

6. The wiring module according to claim 5, wherein
the fixing part includes a second fixing part fixed to a second fixing hole formed in the fixation target, and
the second fixing part is shorter than the insertion part.

7. The wiring module according to claim 6, wherein
the protector includes a plate spring pressed against the fixation target, and
the first fixing part, the second fixing part, and the plate spring are provided away from each other along a longitudinal direction of the fixation target.

8. The wiring module according to claim 1, wherein
the flat wiring member includes a base member and a plurality of wire-like transmission members fixed to the base member,
a section in which the plurality of wire-like transmission members in the flat wiring member are overlapped with the base member is a first section, and a section in which the plurality of wire-like transmission members extend outside the base member is a second section,
the plurality of wire-like transmission members extend to be divided into a plurality of groups for each connection destination different from each other in the second section,
the protector includes a partition convex part provided to the support part to partition the plurality of groups, and
the partition convex part and the insertion part protrude to sides opposite to each other from a same position in the support part.

9. The wiring module according to claim 8, wherein
the fixing part is provided to the base end of the insertion part, and
a release hole for releasing a fixing state of the fixing part fixed to the hole is formed in the partition convex part.
